(19) United States
(12) Patent Application Publication
(10) Pub. No.: US 2026/0126704 A1
(43) Pub. Date: May 7, 2026

(54) Electronic Device

(71) Applicant: Shenzhen Reolink Technology Co., Ltd., Shenzhen (CN)

(72) Inventors: Zhanghui Qin, Shenzhen (CN); Guixing Wang, Shenzhen (CN)

(21) Appl. No.: 19/437,642

(22) Filed: Dec. 31, 2025

(30) Foreign Application Priority Data
Jan. 13, 2025 (CN) 202520076318.1

(51) Int. Cl. G03B 17/08; F21V 5/00; F21V 23/04; F21V 31/00; F21V 31/03; F21V 33/00; F21Y 115/10; G03B 15/05; G03B 31/00; H04N 23/51; H05B 47/11

(52) U.S. Cl. CPC G03B 17/08; F21V 5/004; F21V 23/0464; F21V 31/005; F21V 31/03; F21V 33/0056; G03B 15/05; G03B 31/00; H04N 23/51; H05B 47/11; F21V 2200/20; F21Y 2115/10

(57) ABSTRACT

The present application relates to a waterproofing electronic device. The electronic device includes a housing, a circuit board, and a light-transmitting cover plate; wherein the light-transmitting cover plate is hermetically covered on the housing, the circuit board is disposed inside the housing at a position opposite to the light-transmitting cover plate, and a lighting element and a sound-receiving element are disposed on one side of the circuit board facing the light-transmitting cover plate; and a sound-receiving hole is formed in the light-transmitting cover plate at a position opposite to the sound-receiving element, a waterproof and breathable component is disposed between the sound-receiving element and an inner surface of the light-transmitting cover plate around the sound-receiving hole, and the waterproof and breathable component covers the sound-receiving hole. In summary, the electronic device can optimize the circuit layout, and improve the lighting effect.

### TECHNICAL FIELD

The present application relates to the technical field of device waterproofing, and more particularly relates to an electronic device.

### BACKGROUND

For some electronic devices, in order to make the internal structure layout compact, a lighting element and a sound-receiving element inside a housing are generally mounted on a same circuit board with relatively small spacing between them.

Since the housing needs to be provided with a hole at a position of the sound-receiving element for receiving sound, water vapor is likely to enter an interior of the housing. The water vapor entering the interior may adhere to a light-transmitting cover plate through which light rays of the lighting element passes to form water mist. Once the water mist is formed, the light rays emitted by the lighting element will be diffusely reflected, thereby affecting the lighting effect.

### SUMMARY

In view of the above problem, an example of the present application provides an electronic device, which can optimize the circuit layout, and improve the lighting effect while facilitating the overall assembly.

An example of the present application provides an electronic device, including: a housing, a circuit board, and a light-transmitting cover plate; wherein the light-transmitting cover plate is hermetically covered on the housing, the circuit board is disposed inside the housing at a position opposite to the light-transmitting cover plate, and a lighting element and a sound-receiving element are disposed on one side of the circuit board facing the light-transmitting cover plate; and a sound-receiving hole is formed in the light-transmitting cover plate at a position opposite to the sound-receiving element, a waterproof and breathable component is disposed between the sound-receiving element and an inner surface of the light-transmitting cover plate around the sound-receiving hole, and the waterproof and breathable component covers the sound-receiving hole.

In an optional manner, the waterproof and breathable component includes a waterproof and breathable film and a soft rubber sleeve, the soft rubber sleeve is wrapped around the sound-receiving element, and a sound-receiving channel is formed in the soft rubber sleeve at a position opposite to the sound-receiving hole; and the waterproof and breathable film is clamped between the soft rubber sleeve and an inner surface of the light-transmitting cover plate.

In an optional manner, a limiting groove is formed in the inner surface of the light-transmitting cover plate, the sound-receiving hole is formed in the limiting groove, the waterproof and breathable film is at least partially accommodated inside the limiting groove, and the soft rubber sleeve covers a notch of the limiting groove and presses the waterproof and breathable film against the sound-receiving hole in the limiting groove.

In an optional manner, an annular protrusion is disposed on the inner surface of the light-transmitting cover plate, the annular protrusion surrounds a periphery of the limiting groove, and an accommodating chamber is formed in a space of an inner circumference of the annular protrusion; and the soft rubber sleeve is accommodated in the accommodating chamber and tightly clamped between the inner surface of the light-transmitting cover plate and the circuit board.

In an optional manner, a mounting opening is formed in the housing, an edge of the cover plate extends to form an insertion wall, the insertion wall is inserted into the mounting opening, and a sealing ring is clamped between a surface of an outer periphery of the insertion wall and a surface of an inner circumference of the mounting opening.

In an optional manner, a platform-shaped protrusion is disposed on the inner surface of the light-transmitting cover plate, a groove is formed in the platform-shaped protrusion, a notch of the groove is opposite to the lighting element, and a bottom surface of the groove is a concave curved surface.

In an optional manner, a light-uniformizing boss is disposed on an outer surface of the light-transmitting cover plate opposite to the platform-shaped protrusion, and a microlens array is formed on a surface of the light-uniformizing boss.

In an optional manner, a photosensitive element is further disposed on the circuit board, light guide columns are disposed on both the inner surface and the outer surface on the light-transmitting cover plate opposite to the photosensitive element, and reflective films are wrapped around outer peripheries of the light guide columns.

In an optional manner, a recessed portion is formed in the housing, an opening of the recessed portion forms the mounting opening, the circuit board is disposed inside the recessed portion, and the light-transmitting cover plate is buckled on the recessed portion; and a threaded groove is formed in the inner surface of the light-transmitting cover plate, a first through hole is formed in a bottom of the recessed portion at a position opposite to the threaded groove, a second through hole is formed in the circuit board at a position opposite to the threaded groove, the electronic device further includes a fastener, and the fastener passes through the first through hole and the second through hole from an interior of the housing and then is connected to the threaded groove.

In an optional manner, the electronic device is a camera, and the housing is provided with a lens on at least one side of the circuit board.

In the electronic device provided by the example of the present application, both the lighting element and the sound-receiving element are integrated on one side of the circuit board facing the light-transmitting cover plate, so as to achieve the purpose of compact circuit layout. Considering that the housing has a relatively large volume, there will be much inconvenience in the operation of forming holes in the housing. Based on this, the sound-receiving hole is transferred to the light-transmitting cover plate in a manner of covering the lighting element and the sound-receiving element by the light-transmitting cover plate simultaneously. Compared with the housing, the light-transmitting cover plate has a small volume, thereby being more convenient for the operation of forming holes. Finally, in order to prevent the lighting effect from being affected by water mist formed due to water vapor entering the interior and adhering to the inner surface of the light-transmitting cover plate, the waterproof and breathable component covers an inner side of the sound-receiving hole while hermetically connecting the light-transmitting cover plate to the housing, and the waterproof and breathable component blocks the entry of the water vapor and allows sound to enter normally, thereby achieving the purposes of sealing an internal space of the light-transmitting cover plate and enabling the sound-receiving element to receive sound normally.

### BRIEF DESCRIPTION OF THE DRAWINGS

By reading the detailed description of the preferred embodiments below, various other advantages and benefits will become clear to those of ordinary skill in the art. The accompanying drawings are only for the purpose of illustrating the preferred embodiments and are not considered as limiting the present application. Moreover, the same reference numerals are used to denote the same parts throughout the drawings. In the drawings:

FIG. 1 is a three-dimensional view of an electronic device provided by an example of the present application;

FIG. 2 is an exploded view of the electronic device provided by an example of the present application;

FIG. 3 is a cross-sectional view at a sound-receiving hole in the electronic device provided by an example of the present application;

FIG. 4 is an exploded view of a light-transmitting cover plate and a waterproof and breathable component in the electronic device provided by an example of the present application from an inner side perspective;

FIG. 5 is a three-dimensional view of the light-transmitting cover plate in the electronic device provided by an example of the present application from an outer side perspective;

FIG. 6 is a partial enlarged view of FIG. 5 at a position A; and

FIG. 7 is an exploded view of the electronic device provided by an example of the present application.

Reference numerals in the specific embodiments are as follows:
100. electronic device; 101. camera;
110. housing; 111. mounting opening; 112. recessed portion; 1121. first through hole; 1122. positioning column; 1123. clamping interface;
120. circuit board; 121. lighting element; 122. sound-receiving element; 123. photosensitive element; 124. second through hole; 125. positioning hole;
130. light-transmitting cover plate; 131. insertion wall; 1311. mounting groove; 132. sealing ring; 133. sound-receiving hole; 134. limiting groove; 135. annular protrusion; 1351. accommodating chamber; 136. platform-shaped protrusion; 1361. groove; 137. light-uniformizing boss; 1371. microlens array; 138. light guide column; 139. threaded groove; 1301. buckle;
140. waterproof and breathable component; 141. waterproof and breathable film; 142. soft rubber sleeve; 1421. sound-receiving channel;
150. fastener;
160. lens;
170. covering element; 171. light exit hole; 172. hole; and 173. shooting opening.

### DETAILED DESCRIPTION OF THE INVENTION

The examples of the technical solutions of the present application will be described in detail below with reference to the accompanying drawings. The following examples are only used to more clearly illustrate the technical solutions of the present application, and therefore are only used as instances, and cannot be used to limit the protection scope of the present application.

In order to make the internal circuit layout of a housing compact and meet the requirement of device miniaturization, in the present application, a lighting element (for example, which may be an LED lamp bead) and a sound-receiving element (for example, which may be a microphone) are also mounted on a same circuit board compactly. Further, considering that the housing needs to be provided with a hole at a position opposite to the sound-receiving element for receiving sound, and needs to be provided with a hole at a position opposite to the lighting element and cover a light-transmitting cover plate (for example, which may be a lens, and the like) to ensure that light rays emitted by the lighting element can irradiate to the outside, in order to simplify production and manufacturing working procedures, in the present application, an assembly form in which the light-transmitting cover plate covers the lighting element and the sound-receiving element simultaneously is adopted, and a sound-receiving hole is formed in the light-transmitting cover plate, the operation of forming holes in the housing is not needed. Since the light-transmitting cover plate has a relatively small volume, it is easier to form holes in the light-transmitting cover plate. On this basis, in view of the problem that water mist appears at a light-transmitting position due to water vapor entering the sound-receiving hole, in the present application, a waterproof and breathable component is adopted to cover an inner side of the sound-receiving hole, so as to ensure that the entry of the water vapor is blocked as much as possible while receiving sound normally, thereby ensuring the lighting effect of the lighting element.

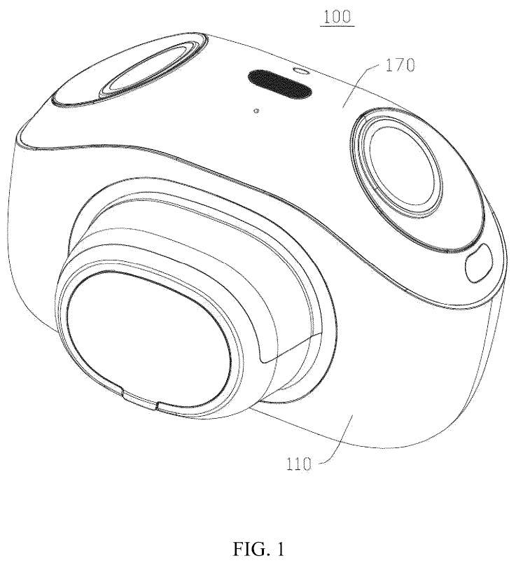

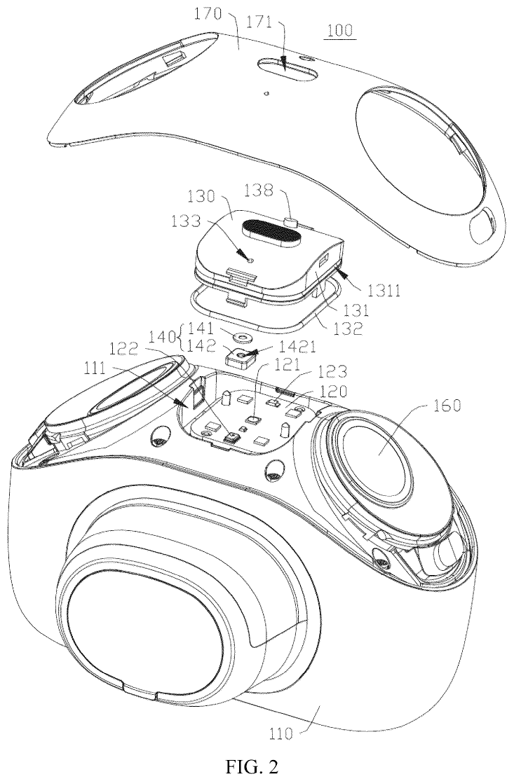

Referring to FIG. 1 and FIG. 2, FIG. 1 shows a three-dimensional structure of an electronic device provided by an example of the present application; and FIG. 2 shows a structure of the electronic device in an exploded state. In the figures, the electronic device is illustrated by taking a camera as an instance, which does not constitute a limitation on a specific product type of the electronic device. Other electronic devices having lighting and sound-receiving functions simultaneously also fall within the protection scope of the present application.

As shown in FIG. 1 and FIG. 2, the electronic device 100 provided by the example of the present application includes: a housing 110, a circuit board 120, and a light-transmitting cover plate 130. The light-transmitting cover plate 130 is hermetically covered on the housing 110. In a specific example shown in FIG. 2, a mounting opening 111 may be formed in the housing 110, an edge of the light-transmitting cover plate 130 may perpendicularly or obliquely extend to form an insertion wall 131, the insertion wall 131 is inserted into the mounting opening 111, and a sealing ring 132 is clamped between a surface of an outer periphery of the insertion wall 131 and a surface of an inner circumference of the mounting opening 111, so as to form an interference fit by clamping the sealing ring 132 between the surface of the outer periphery of the insertion wall 131 and the surface of the inner circumference of the mounting opening 111, thereby achieving the sealing for an assembly gap between the light-transmitting cover plate 130 and the housing 110. Further, a mounting groove 1311 may be formed in the outer periphery of the insertion wall 131, and the sealing ring 132 is sleeved in the mounting groove 1311 to achieve positioning. Of course, in some other examples, the light-transmitting cover plate 130 may also be mounted and hermetically covered on the housing 110 by means of sealed bonding with a sealant or connection with a threaded fastener.

It should be noted that the light-transmitting cover plate 130 may be entirely light-transmitting, and may also be prepared to be in a structure form in which a position opposite to a lighting element 121 is light-transmitting and other positions are opaque through processes such as double-shot injection molding.

The circuit board 120 is disposed inside the housing 110 at a position opposite to the light-transmitting cover plate 130, and the lighting element 121 and a sound-receiving element 122 are disposed on one side of the circuit board 120 facing the light-transmitting cover plate 130, wherein an LED lamp, a fluorescent lamp, and the like may be adopted as the lighting element 121, and for example, a microphone, and the liked may be adopted as the sound-receiving element 122.

A sound-receiving hole 133 is formed in the light-transmitting cover plate 130 at a position opposite to the sound-receiving element 122, a waterproof and breathable component 140 is disposed between an inner surface around the sound-receiving hole 133 on the light-transmitting cover plate 130 and the sound-receiving element 122, and the waterproof and breathable component 140 covers the sound-receiving hole 133, so that the waterproof and breathable component 140 may isolate water vapor and allow a gas to pass through, so as to have the effects of allowing sound to pass through and preventing the water vapor from entering an interior of the housing 110.

In the electronic device 100 provided by the example of the present application, both the lighting element 121 and the sound-receiving element 122 are integrated on one side of the circuit board 120 facing the light-transmitting cover plate 130, so as to achieve the purpose of compact circuit layout. Considering that the housing 110 has a relatively large volume, there will be much inconvenience in the operation of forming holes in the housing 110. Based on this, the sound-receiving hole 133 is transferred to the light-transmitting cover plate 130 in a manner of covering the lighting element 121 and the sound-receiving element 122 by the light-transmitting cover plate 130 simultaneously. Compared with the housing 110, the light-transmitting cover plate 130 has a small volume, thereby being more convenient for the operation of forming holes. Finally, in order to prevent the lighting effect from being affected by water mist formed due to water vapor entering the interior and adhering to the inner surface of the light-transmitting cover plate 130, the waterproof and breathable component 140 covers an inner side of the sound-receiving hole 133 while hermetically connecting the light-transmitting cover plate 130 to the housing 110, and the waterproof and breathable component 140 blocks the entry of the water vapor and allows sound to enter normally, thereby achieving the purposes of sealing an internal space of the light-transmitting cover plate 130 and enabling the sound-receiving element 122 to receive sound normally.

For a specific structure of the waterproof and breathable component 140, the present application provides an embodiment, specifically as shown in FIG. 2. The waterproof and breathable component 140 includes a waterproof and breathable film 141 and a soft rubber sleeve 142. It should be pointed out herein that a groove is in the center of the waterproof and breathable film 141 shown in FIG. 2, a thin film is at the bottom of the groove, and the thin film have the effects of blocking the water vapor and allowing the gas to pass through.

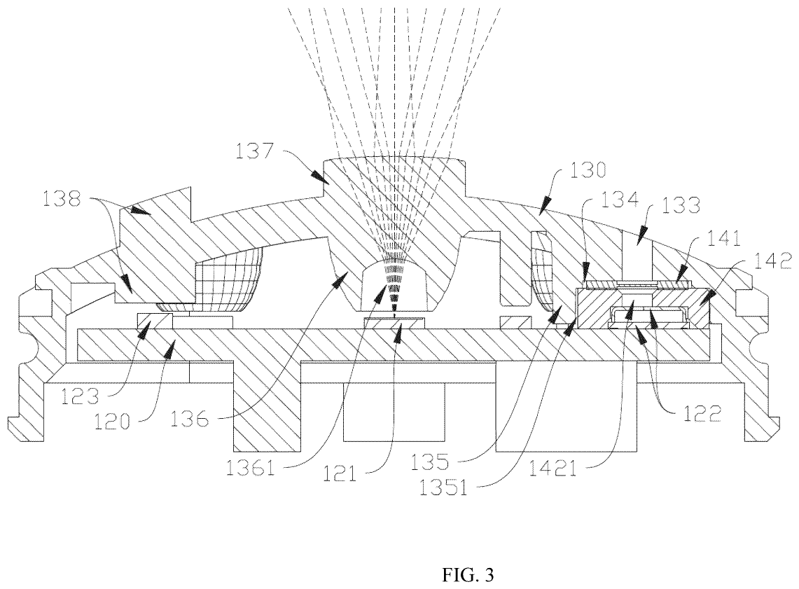

Further combined with a cross-sectional structure at the sound-receiving hole 133 shown in FIG. 3, the soft rubber sleeve 142 is wrapped around the sound-receiving element 122, and a silicone sleeve with a groove in the bottom, and the like may be adopted as the soft rubber sleeve 142, which is buckled on the sound-receiving element 122 to wrap the sound-receiving element 122 therein, so as to achieve the covering and protection of the sound-receiving element 122. Since the soft rubber sleeve 142 does not have the capability of allowing the gas to pass through, a sound-receiving channel 1421 may be formed in the soft rubber sleeve 142 at a position opposite to the sound-receiving hole 133. The waterproof and breathable film 141 is clamped between the soft rubber sleeve 142 and the inner surface of the light-transmitting cover plate 130, and the waterproof and breathable film 141 is pressed against the inner surface of the light-transmitting cover plate 130 at the sound-receiving hole 133 by the soft rubber sleeve 142 to ensure the sealing capability at the sound-receiving hole 133. Sound entering from the sound-receiving hole 133 passes through the waterproof and breathable film 141 and the sound-receiving channel 1421, and then is collected by the sound-receiving element 122, while water vapor entering from the sound-receiving hole 133 is isolated in the sound-receiving hole 133 by the waterproof and breathable film 141.

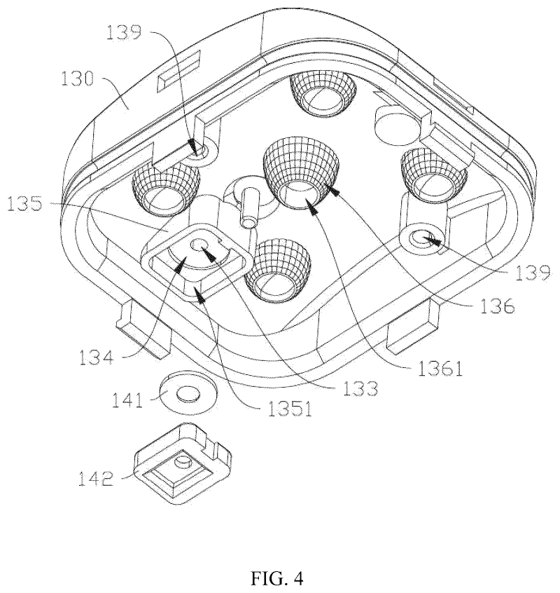

During and after assembly, in order to ensure the accuracy of a position of the waterproof and breathable film 141, and enable the waterproof and breathable film 141 to stably and reliably cover the sound-receiving hole 133 and provide waterproof and breathable functions, continuing to refer to FIG. 3 and further combined with a structure of an inner side of the light-transmitting cover plate 130 shown in FIG. 4, a limiting groove 134 is formed in the inner surface of the light-transmitting cover plate 130, the sound-receiving hole 133 is formed in the limiting groove 134, for example, may be formed in the bottom or a side wall of the limiting groove 134, the waterproof and breathable film 141 is at least partially accommodated inside the limiting groove 134, and the soft rubber sleeve 142 covers a notch of the limiting groove 134 and presses the waterproof and breathable film 141 against the sound-receiving hole 133 in the limiting groove 134.

The limiting groove 134 is formed in the inner surface of the light-transmitting cover plate 130, the sound-receiving hole 133 is formed in the limiting groove 134, and the waterproof and breathable film 141 is pressed against the sound-receiving hole 133 and at least partially accommodated inside the limiting groove 134, so that the waterproof and breathable film 141 may be limited by the limiting groove 134 to prevent sealing failure caused by shifting of the waterproof and breathable film 141 relative to the sound-receiving hole 133. On this basis, pressing the waterproof and breathable film 141 against the sound-receiving hole 133 in the limiting groove 134 by the soft rubber sleeve 142 may better prevent the water vapor from seeping between the waterproof and breathable film 141 and an inner surface of the limiting groove 134. Moreover, even if a small part of water vapor seeps to the notch of the limiting groove 134, pressing and covering the soft rubber sleeve 142 against the notch of the limiting groove 134 may also better prevent electronic parts and components from being damaged by the water vapor further seeping into the circuit board 120, and may also prevent the lighting effect of the lighting element 121 from being affected by the water vapor entering the interior and then adhering to the light-transmitting cover plate 130 simultaneously.

In order to prevent a position of the soft rubber sleeve 142 from shifting, as shown in FIG. 4, an annular protrusion 135 may be disposed on the inner surface of the light-transmitting cover plate 130, the annular protrusion 135 surrounds a periphery of the limiting groove 134, and an accommodating chamber 1351 is formed in a space of an inner circumference of the annular protrusion 135. Further combined with FIG. 3, the soft rubber sleeve 142 is accommodated in the accommodating chamber 1351 and tightly clamped between the inner surface of the light-transmitting cover plate 130 and the circuit board 120, a periphery of the soft rubber sleeve 142 is limited by the annular protrusion 135 to prevent the soft rubber sleeve 142 from shifting, and an interference fit is formed by clamping the soft rubber sleeve 142 between the circuit board 120 and the inner surface of the light-transmitting cover plate 130, so that the soft rubber sleeve 142 may have a better sealing effect.

In order to improve the lighting effect of the lighting element 121, as shown in FIG. 3 and FIG. 4, a platform-shaped protrusion 136 is disposed on the inner surface of the light-transmitting cover plate 130, a groove 1361 is formed in the platform-shaped protrusion 136, a notch of the groove 1361 is opposite to the lighting element 121, and a bottom surface of the groove 1361 is a concave curved surface, so that a solid structure on the light-transmitting cover plate 130 at the bottom of the groove 1361 forms a concave lens, and light rays emitted by the lighting element 121, as shown by dashed lines in FIG. 3, diffuse after passing through the concave lens, thereby increasing the area of an illuminable region and improving the lighting effect.

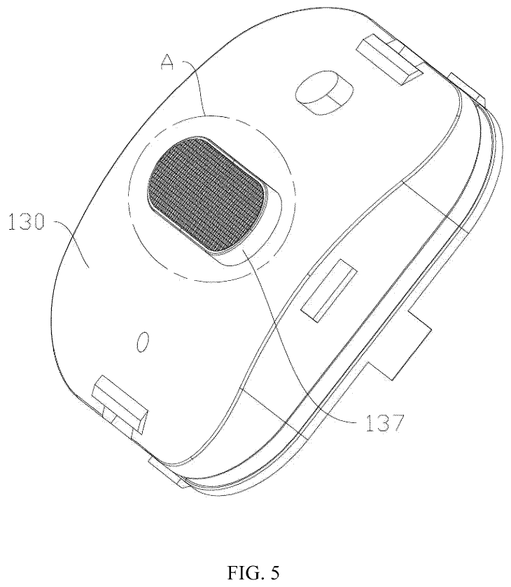

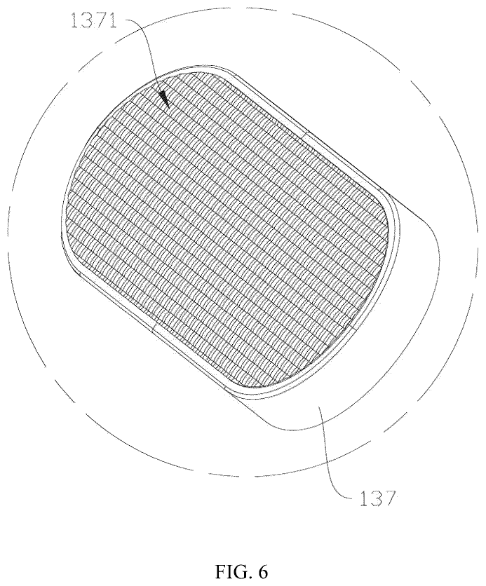

Further, referring to FIG. 3, FIG. 5, and FIG. 6, FIG. 5 shows a three-dimensional structure on an outer side of the light-transmitting cover plate 130, and FIG. 6 shows an enlarged structure at a position A in FIG. 5. In order to make the brightness distribution in an illuminated region uniform, a light-uniformizing boss 137 is disposed on an outer surface of the light-transmitting cover plate 130 opposite to the platform-shaped protrusion 136, and a microlens array 1371 is formed on a surface of the light-uniformizing boss 137.

As shown in FIG. 3, light rays output from the light-uniformizing boss 137 may be scattered by the microlens array 1371, which makes the light intensity distribution more uniform after the light rays reach the illuminated region, that is, the brightness distribution is uniform, thereby achieving a more uniform lighting effect.

Combined with FIG. 2 to FIG. 4, a photosensitive element 123 may further be disposed on the circuit board 120, and a CdS (cadmium sulfide) photoresistor, a photoelectric sensor, a photodiode, and the like may be adopted as the photosensitive element 123, which is mainly used to sense the intensity of external ambient light, so that the electronic device 100 may control the lighting element 121 to be turned on or off according to the intensity of the external ambient light. Light guide columns 138 are disposed on both the inner surface and the outer surface on the light-transmitting cover plate 130 opposite to the photosensitive element 123, and reflective films are wrapped around outer peripheries of the light guide columns 138, so that after entering the light guide columns 138, the external light propagates inside the light guide columns 138 under a reflection effect of the reflective films and finally reaches the photosensitive element 123, thereby ensuring that the photosensitive element 123 can effectively sense the intensity of the external ambient light.

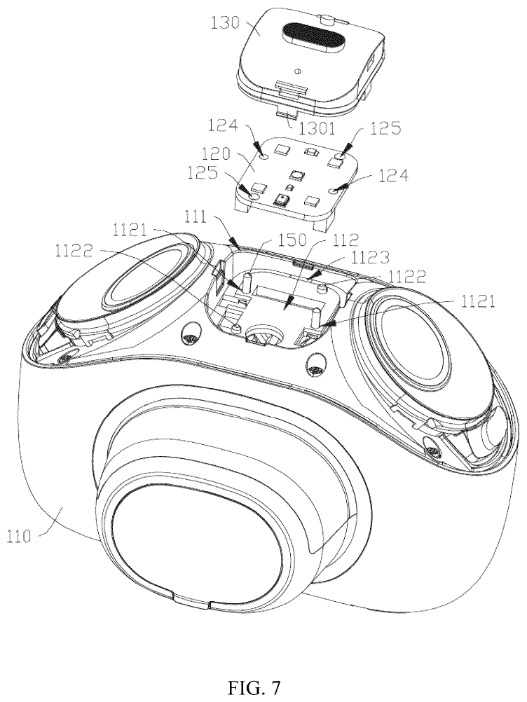

For the assembly of the circuit board 120 in the housing 110, referring to FIG. 7, structures of the housing 110, the circuit board 120, and the light-transmitting cover plate 130 in an exploded state are shown in the figure. A recessed portion 112 may be formed in the housing 110, an opening of the recessed portion 112 forms the above mounting opening 111, the circuit board 120 is disposed inside the recessed portion 112, and the light-transmitting cover plate 130 is buckled on the recessed portion 112. Combined with FIG. 4, a threaded groove 139 is formed in the inner surface of the light-transmitting cover plate 130, a first through hole 1121 is formed in a bottom of the recessed portion 112 at a position opposite to the threaded groove 139, a second through hole 124 is formed in the circuit board 120 at a position opposite to the threaded groove 139, the electronic device 100 further includes a fastener 150, and the fastener 150 passes through the first through hole 1121 and the second through hole 124 from an interior of the housing 110 and then is connected to the threaded groove 139, so as to assemble and fix the circuit board 120 and the light-transmitting cover plate 130 on the housing 110 simultaneously, thereby being beneficial to improving the assembly efficiency.

Further, in order to facilitate the alignment among the first through hole 1121, the second through hole 124, and the threaded groove 139 during assembly, as shown in FIG. 7, a positioning column 1122 may be disposed inside the recessed portion 112, and a positioning hole 125 may be correspondingly formed in the circuit board 120. During assembly, after placing the circuit board 120 inside the recessed portion 112, the positioning column 1122 is inserted into the positioning hole 125 to achieve the pre-positioning of the circuit board 120 inside the recessed portion 112, thereby ensure that the first through hole 1121 and the second through hole 124 are aligned with each other, and avoiding the horizontal displacement of the circuit board 120. In addition, buckles 1301 may be disposed on edges of two opposite sides of the bottom of the light-transmitting cover plate 130, and clamping interfaces 1123 are formed at corresponding positions inside the recessed portion 112. After pre-positioning the circuit board 120 in the recessed portion 112, the light-transmitting cover plate 130 is buckled and connected to the recessed portion 112 through the clamping between the buckles 1301 and the clamping interfaces 1123. At this moment, the circuit board 120 and the light-transmitting cover plate 130 have been assembled on the housing 110. Further, the fastener 150 passes through from the inner side and is connected to the threaded groove 139 in the light-transmitting cover plate 130 after passing through the first through hole 1121 and the second through hole 124, so that the circuit board 120 and the light-transmitting cover plate 130 may be firmly connected to the housing 110, thereby ensuring the stability and reliability of an overall structure of the electronic device 100.

In a specific example shown in FIG. 2, the electronic device 100 is a camera 101, and the housing 110 is provided with a lens 160 on at least one side of the light-transmitting cover plate 130. The camera 101 may specifically be a dual-sided camera shown in the figure, that is, two lenses 160 are included, or of course, only one lens 160 may be provided, and the specific number of the lenses 160 is not limited herein.

For the camera 101, the lighting element 121 is mainly used to provide supplementary light in the case of insufficient light in a shooting region of the lens 160, and based on good sealing treatment of the sound-receiving hole 133 in the example of the present application, it can be ensured that water mist is not likely to appear on the light-transmitting cover plate 130, thereby ensuring a light supplementing effect of the lighting element 121.

Further, combined with FIG. 1 and FIG. 2, a covering element 170 is further disposed on the housing 110, and the covering element 170 is covered outside the light-transmitting cover plate 130 to have certain decorative and protective effects on the light-transmitting cover plate 130. Moreover, a light exit hole 171 is formed in the light-transmitting cover plate 130 at a position opposite to the lighting element 121 to ensure that light rays emitted by the lighting element 121 may pass through the light-transmitting cover plate 130 and then exit from the light exit hole 171 for lighting and supplementing light. A hole 172 is formed in the covering element 170 at a position opposite to the sound-receiving hole 133 to ensure the normal collection of external sound by the sound-receiving element 122. In addition, a shooting opening 173 is further formed in the covering element 170, the covering element 170 is sleeved on an outer periphery of the lens 160 through the shooting opening 173, thereby also having certain decorative and protective effects on the lens 160.

Finally, it should be noted that the various examples above are only used to illustrate the technical solutions of the present application, but not used to limit them; although the present application has been described in detail with reference to the foregoing examples, those of ordinary skill in the art should understand that they may still modify the technical solutions described in the foregoing examples, or equivalently replace some or all of the technical features; and these modifications or replacements do not make the essence of the corresponding technical solutions deviate from the scope of the technical solutions of various examples of the present application. In particular, as long as there is no structural conflict, the technical features mentioned in the various examples may be combined in any way.

The invention claimed is:

1. An electronic device, comprising: a housing, a circuit board, and a light-transmitting cover plate;
wherein the light-transmitting cover plate is hermetically covered on the housing, the circuit board is disposed inside the housing at a position opposite to the light-transmitting cover plate, and a lighting element and a sound-receiving element are disposed on one side of the circuit board facing the light-transmitting cover plate; and
a sound-receiving hole is formed in the light-transmitting cover plate at a position opposite to the sound-receiving element, a waterproof and breathable component is disposed between the sound-receiving element and an inner surface of the light-transmitting cover plate around the sound-receiving hole, and the waterproof and breathable component covers the sound-receiving hole.

2. The electronic device according to claim 1, wherein the waterproof and breathable component comprises a waterproof and breathable film and a soft rubber sleeve, the soft rubber sleeve is wrapped around the sound-receiving element, and a sound-receiving channel is formed in the soft rubber sleeve at a position opposite to the sound-receiving hole; and
the waterproof and breathable film is clamped between the soft rubber sleeve and an inner surface of the light-transmitting cover plate.

3. The electronic device according to claim 2, wherein a limiting groove is formed in the inner surface of the light-transmitting cover plate, the sound-receiving hole is formed in the limiting groove, the waterproof and breathable film is at least partially accommodated inside the limiting groove, and the soft rubber sleeve covers a notch of the limiting groove and presses the waterproof and breathable film against the sound-receiving hole in the limiting groove.

4. The electronic device according to claim 3, wherein an annular protrusion is disposed on the inner surface of the light-transmitting cover plate, the annular protrusion surrounds a periphery of the limiting groove, and an accommodating chamber is formed in a space of an inner circumference of the annular protrusion; and
the soft rubber sleeve is accommodated in the accommodating chamber and tightly clamped between the inner surface of the light-transmitting cover plate and the circuit board.

5. The electronic device according to claim 1, wherein a mounting opening is formed in the housing, an edge of the light-transmitting cover plate extends to form an insertion wall, the insertion wall is inserted into the mounting opening, and a sealing ring is clamped between a surface of an outer periphery of the insertion wall and a surface of an inner circumference of the mounting opening.

6. The electronic device according to claim 1, wherein a platform-shaped protrusion is disposed on the inner surface of the light-transmitting cover plate, a groove is formed in the platform-shaped protrusion, a notch of the groove is opposite to the lighting element, and a bottom surface of the groove is a concave curved surface.

7. The electronic device according to claim 6, wherein a light-uniformizing boss is disposed on an outer surface of the light-transmitting cover plate opposite to the platform-shaped protrusion, and a microlens array is formed on a surface of the light-uniformizing boss.

8. The electronic device according to claim 1, wherein a photosensitive element is further disposed on the circuit board, light guide columns are disposed on both the inner surface and the outer surface on the light-transmitting cover plate opposite to the photosensitive element, and reflective films are wrapped around outer peripheries of the light guide columns.

9. The electronic device according to claim 1, wherein a recessed portion is formed in the housing, an opening of the recessed portion forms the mounting opening, the circuit board is disposed inside the recessed portion, and the light-transmitting cover plate is buckled on the recessed portion; and
a threaded groove is formed in the inner surface of the light-transmitting cover plate, a first through hole is formed in a bottom of the recessed portion at a position opposite to the threaded groove, a second through hole is formed in the circuit board at a position opposite to the threaded groove, the electronic device further comprises a fastener, and the fastener passes through the first through hole and the second through hole from an interior of the housing and then is connected to the threaded groove.

10. The electronic device according to claim 1, wherein the electronic device is a camera, and the housing is provided with a lens on at least one side of the light-transmitting cover plate.
